(19) United States
(12) Patent Application Publication
(10) Pub. No.: US 2004/0249649 A1
(43) Pub. Date: Dec. 9, 2004

(54) Payment method and system for telecommunications

(76) Inventors: Robert P. Stratton, Toronto (CA); William Martin Snelgrove, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/479,181

(22) PCT Filed: May 13, 2002
(86) PCT No.: PCT/CA02/00699

(30) Foreign Application Priority Data
May 31, 2001 (CA) 2349278

(51) Int. Cl. G06F 17/60

(52) U.S. Cl. 705/1; 705/34

(57) ABSTRACT

A method which allows a callee and/or a caller to be billed for telecommunications and which permits notice of charges to be provided to callers, and permits acceptance of charges by callers, prior to completing a connection is disclosed. The invention allows callees to define charges to be applied to calls they receive to be credited to their billing account and/or to waive such charges for some callers and/or in some time periods. Additional information can also be supplied to a caller before the call is completed to the callee, such as an identification of a difference in time zones between the caller and the callee.

### FIELD OF THE INVENTION

The present invention relates to a payment method and system for telecommunications networks. More specifically, the present invention relates to a payment method and system which allows a called party and/or the calling party to be billed for telecommunications and which permits notice of charges to be provided to callers, and permits acceptance of charges by callers, prior to completing a connection.

### BACKGROUND OF THE INVENTION

Telecommunications have undergone revolutionary developments over the last few decades. Advancements in switching technology, cellular networks, voice mail, prepaid cellular services and other developments have resulted in significant improvements in available services, user service levels and capabilities.

At the same time, these developments have resulted in some confusing, or undesired, developments. For example, the proliferation of cell phones, fax machines and dial up internet and other data access services have resulted in shortages of telephone numbers in some area codes and additional shortages are contemplated in the future. These shortages are being addressed by the introduction of additional, previously unused, area codes. For example, New York City, Los Angeles, San Francisco and Toronto, Canada have had additional area codes defined for their areas. To date, two schemes have been employed in North America to add additional area codes to an area, namely: geographic splits; and/or overlays.

A geographic split involves splitting the existing area code into two or more geographic areas and leaving the existing area code in place in a selected one of the areas and assigning new area codes to the other areas. A disadvantage of this scheme is that everyone in the new area codes must change the area codes of their telephone numbers, but an advantage is that the scheme is less confusing to use (provided that the geographic basis for the split is selected in a reasonable manner.)

An overlay involves assigning another, new, area code to an existing geographic area. Under this scheme, all users with a number existing prior to the overlay maintain that number and the original area code, but numbers assigned after the overlay can be assigned with either the old area code or the new one. Thus a subscriber with two telephone lines obtained at different times may have one in one area code and the other in another area code.

Clearly, one of the consequences of having multiple area codes within a geographic area is that calling schemes can become non-obvious. In particular, the toll status (whether long distance charges will be incurred) of a call can be non-obvious to the caller. For example, in Toronto it is possible that a call initiated by a calling party (the “caller”) in the 905 area code to another party (the “callee”) in the 905 area code can be either a local (non-toll) or long distance (toll) call depending upon the actual locations of the two parties. Also, under the present Canadian dialing scheme, a toll call must be preceded by a “1” and the inability to inherently identify the toll status of a call before it is dialed can result in the user having to re-dial the number when an incorrect toll status is assumed.

In at least some U.S. centers, a dialed number must be preceded by a “1”, even for non-toll calls, to numbers in another, overlayed, area code, while other calls, which are toll calls, can be made without requiring the dialing of the “1”. The absence of any prior implicit information about the toll status of a proposed call can create confusion and/or frustration on the part of the parties.

Further, present dialing plans can confuse automated services, such as telephones with call-back features, and/or computer modem dialers which cannot determine from the number/area code whether a “1” should be pre-pended to a dialed number.

Recently, Number Portability has been proposed and is being mandated in some jurisdictions. Number Portability allows a telephone network subscriber to move their telephone number with them as they move from location to location and/or from network to network, even when moving large geographic distances. For example, it is proposed that a telephone network subscriber will be able to move from New York to Los Angeles and keep the same telephone number and area code. Clearly this will further exacerbate the confusion with dialing schemes.

Cellular telephone services and/or call features such as call forwarding have also resulted in confusion and/or undesired results. For example, due to the explicit mobility of a cellular telephone, a caller dialing such a telephone can be making a local call in one instance and a toll call in another. Presently, in North America air time charges, roam charges (often incurred when using the cellular telephone outside its “home” network) and toll charges incurred to connect to the cellular telephone are charged to the account of the cellular telephone owner. In European countries, airtime charges are incurred by the caller while other charges are incurred by the cellular telephone user. While in many cases these schemes are equitable and/or desirable, there are many other cases wherein it is not.

For example, a incorrectly dialed number (a wrong number) which connects to a cellular telephone can result in the cellular telephone owner incurring airtime charges for an entirely undesired call. If, in the same circumstances, the cellular telephone owner is not in their home network, significant roam and/or toll charges can be incurred in addition to the air time charges. Further, if the cellular telephone owner is temporarily in another time zone, an incoming call can interrupt sleep or otherwise disturb the callee at inappropriate times.

Also, calls intended for the cellular phone, but which are of an importance level that does not justify incurring long distance and roaming charges, will still be connected to the callee as the caller does not know the status of cellular telephone phone being called. For example, a dentist's office trying to provide a telephone reminder of a future appointment to a client, who is a cellular telephone user from New York City and who is in San Francisco on a business trip when the call is made, will inadvertently call that client at a time three hours earlier than intended and will likely result in the callee incurring long distance and roaming charges. As some cellular telephone networks allow for global service, even more extreme examples of such calls can occur (New York to Tokyo, etc.). Another troublesome example is that of a telemarketing concern making such a call—in such a case the cellular telephone user likely gets no benefit at all from the call and yet can end up incurring significant charges for receiving the call.

While call display can be employed by the cellular telephone owner (if it is available) to screen calls to some extent before accepting them, this is not an entirely satisfactory technique as it requires the telephone owner to be able to identify all significant incoming calls by the displayed information. In particular, if the cellular telephone owner has a wide range of friends or business contacts, this may not be feasible or convenient.

It is therefore desired to have some method and/or system which reduces dialing scheme confusion and/or which prevents a callee from incurring long distance and/roaming charges for undesired, or low priority, calls.

### SUMMARY OF THE INVENTION

It is an object of the present invention to provide a novel which obviates or mitigates at least some of the above-identified disadvantages of the prior art.

According to a first aspect of the present invention, there is provided a payment method for a telecommunications network providing a connection between a caller and a callee, comprising the steps of:

said caller indicating to said telecommunications system a desired callee to be connected to;

said telecommunications network determining the status of said desired callee to determine if charges will be incurred by said caller if said connection is completed;

if charges will be incurred by said caller, advising said caller of said charges and receiving input from said caller indicating an acceptance or refusal of said charges;

completing said connection between said caller and said callee if said received input indicates acceptance by said caller;

posting the resulting charges to a billing account of said caller.

According to another aspect of the present invention, there is provided a method for allowing a caller to accept charge rates for a call before being billed said charges, in a telecommunications network consisting of a plurality of telephony devices interconnected by switching nodes, said telecommunications network being operable to determine said charge rates in advance of connecting said call, said method consisting of the following steps:

a caller dialing a desired destination number;

said telecommunications network checking to see if charges will be incurred;

said caller being advised of said charges;

said caller accepting or declining said charges, and

if said charges are accepted, then said call to said destination number is completed.

The present invention provides a method which allows a callee and/or a caller to be billed for telecommunications and which permits notice of charges to be provided to callers, and permits acceptance of charges by callers, prior to completing a connection. The invention allows callees to define charges to be applied to calls they receive to be credited to their billing account and/or to waive such charges for some callers and/or in some time periods. Additional information can also be supplied to a caller before the call is completed to the callee, such as an identification of a difference in time zones between the caller and the callee.

According to another aspect of the present invention, there is provided a telecommunications network operable to collect payment from a caller upon completion of the connection to a callee, with said charges being determined by the status of said callee, consisting of:

at least two switching nodes, of which at least one of said at least two switching nodes is operable to determine said status of said callee;

a backbone network connecting said at least two switching nodes;

at least two telephony devices operable to communicate with said at least two switching nodes; and

at least one interactive voice response system, operable to notify said caller of said charges and receive acceptance of said charges by said caller.

The present invention relates to a payment system and method for telecommunications networks which allows a called party and/or the calling party to be billed for telecommunications and which permits notice of charges to be provided to callers, and permits acceptance of charges by callers, prior to completing a connection. The called party can define at least some of the parameters relating to these charges.

### BRIEF DESCRIPTION OF THE DRAWINGS

Preferred embodiments of the present invention will now be described, by way of example only, with reference to the attached Figures, wherein:

FIG. 1 shows a schematic representation of a public switched telephone network in accordance with the present invention; and

FIG. 2 shows a method for charging callers for charges incurred by the callees in accordance with another embodiment of the invention.

### DETAILED DESCRIPTION OF THE INVENTION

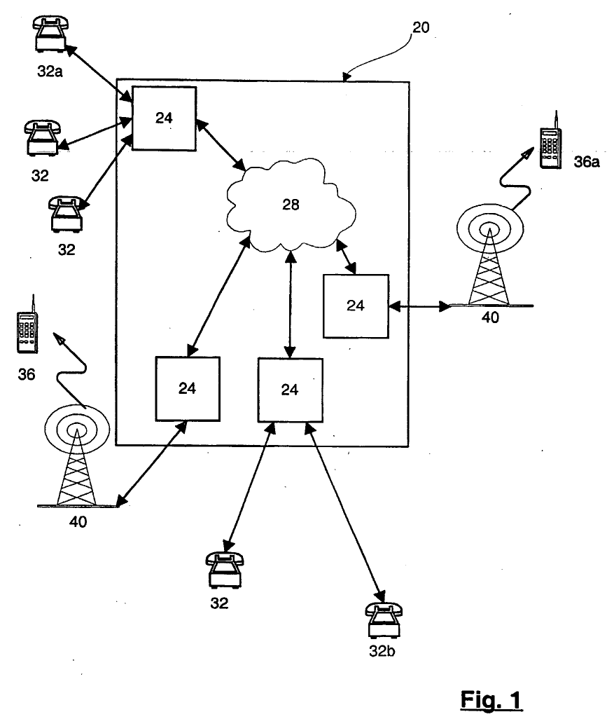

FIG. 1 shows a public switched telephone network (PSTN) 20 in accordance with an embodiment of the present invention. PSTN 20 comprises two or more switching nodes 24, interconnected by a backbone network 28 comprising signal and message trunks. Switching nodes 24 can consist of any known and appropriate switching device. Typically, switching nodes 24 consist of a central office (CO) containing a Class 5 switch. The Class 5 switch interconnects via backbone network 28 with other tiers of switching offices (class 1 though class 4), that are toll offices. Other types of switching node 24 are within the scope of the invention.

Wire line user telephony devices 32, such as telephone sets or fax machines, can be connected to switching nodes 24 through local loops. In general, the connection between a telephony device 32 and a switching node 24 is considered to be a local call (although in some areas, usage charges still apply). Wireless (cellular) telephony devices 36 can also connect to backbone network 28 through wireless base stations 40, typically comprising base station controllers and mobile switching centers. A connection to a wireless telephony device 36, via a base station 40, is not always considered to be a local call, as the user of wireless telephony device 36 may be “roaming” outside his or her local service area.

User connections are carried between switching nodes 24 on communication trunks in backbone network 28 and switching nodes 24 also intercommunicate on signaling trunks in backbone network 28 to set up and tear down connections. In addition, switching nodes 24 are operable to communicate with billing record systems 44 over the same signaling trunks or via other means to determine and record billing information, if any, associated with a connection. Also attached to backbone network 28 is at least one Interactive Voice Response system (IVR) 48, which can be a software application running within network 20, or can be a dedicated IVR system, such as those manufactured by Nortel Networks and others. IVR system 48 is operable to provide automated responses to customers, and will be described further below.

Billing systems have become increasingly sophisticated to accommodate the advanced calling services which have been developed and the deployment of mobile telephone networks, etc. One function of the billing system is to apply the appropriate billing rules for connections between various users of PSTN 20 and to ultimately produce data records of all connections, which data records are stored in, and later processed by, billing record system 44 to invoice users.

In a conventional billing system, a call-detail record (CDR) is created in switching node 24. A CDR normally contains the originating number, the terminating number and the call's start and end times. CDRs are normally stored in a database in billing record system 44 and then later rated in a batch process. The call rate is determined by examining the CDR to see if the call is, for example, an 800 number, a local call that is covered by a local-area calling plan, or a toll call. Information such as the time the call was placed and the distance between callers is also used to calculate the call rate. Once all the calls have been rated, this information is stored until the invoice is run, usually once a month in North America. When the invoice is run, other non-usage items such as refunds or charges can be applied to the bill, such as volume discounts or monthly fees.

Newer, real-time billing systems are also known. For example, U.S. Pat. No. 6,157,823 describes a system for prepaid cellular services, in which users' prepaid accounts are debited by a fixed amount for each predetermined period of time which elapses.

In North America, such billing rules typically define that a local call, over land lines, does not incur toll charges. In Europe and other parts of the world, the billing rules define that local calls over land lines do incur toll charges, which are allocated to the originator of the call. In most, if not all, locations around the world, a long distance call incurs toll charges which are allocated to the originator of the call (with the exception of “toll free” services such as 1-800 dialing).

Mobile telephones have introduced additional considerations. For example, in most areas of the world, both calls received at, or initiated from, a mobile telephone incur local usage charges, typically referred to as airtime charges, which are allocated to the owner of the mobile telephone in North America and to the caller in Europe. In this context, ‘local’ is determined relative to the location of the mobile telephone and the location of the called party when the call is initiated, e.g.—a mobile user whose home network is in San Francisco and who is visiting New York can make ‘local’ calls to people in New York, although perhaps incurring roaming charges. Long distance calls initiated by a mobile telephone user incur toll charges which are allocated to the mobile telephone owner in addition to the airtime charges. Again, in this context, ‘long distance’ is determined relative to the location of the mobile telephone and the called party when the call is initiated, e.g.—calls to people in San Francisco from the above-mentioned San Francisco-based user will be ‘long distance’ calls while the user is in New York.

A call to a mobile telephone which is outside of its home area can also be deemed to be a long distance call, and long distance charges (determined between the home area and the actual location of the mobile telephone) are also allocated to the owner of the mobile telephone in addition to the airtime charges.

As described above, various difficulties and undesired consequences can result with the existing telephone switch and legacy billing systems. For example, if the user of telephony device 32a in FIG. 1 calls telephony device 32b, under many scenarios they will not implicitly (before or while dialing) be able to tell if that connection will be billed as a local (non toll) or long distance (toll) call. Further, if the user of telephony device 32a in FIG. 1 calls mobile telephony device 36a, the charges incurred by the owner of mobile telephony device 36a will vary depending upon the relative locations of mobile telephony device 36a and the caller and thus the owner of the mobile telephony device 36a will not know what charges he will incur if he answers the telephone. Specifically, if mobile telephony device 36a is in its home network, only airtime charges will be incurred by its owner. If mobile telephony device 36a is outside its home network, roam charges will often be incurred by its owner, in addition to the airtime charges, without the knowledge of the caller and, if the caller is not located in the same location as the present location of the mobile telephony device 36a, long distance charges between the home network of the mobile telephony device 36a and its present location will also be incurred by the owner of device 36a.

Further complications can occur if call forwarding is activated by the owner of a telephony device 32a to transfer calls to their mobile telephony device 36a. For example, the owner of telephony device 32b in New York can call the owner of telephony device 32a in Boston, and this is normally a long distance call. The owner of telephony device 32a has activated call forwarding for that telephony device to their mobile telephony device 36a as they have traveled to Pittsburgh. Thus, the call from telephony device 32b in New York is received at mobile telephony device 36a in Pittsburgh. Under this scenario, the owner of telephony device 32b is charged for the long distance charges from New York to Boston and the owner of telephony device 32a is charged for the long distance charges from Boston to Pittsburgh and is charged for airtime and roaming charges in Pittsburgh for use of mobile telephony device 36a.

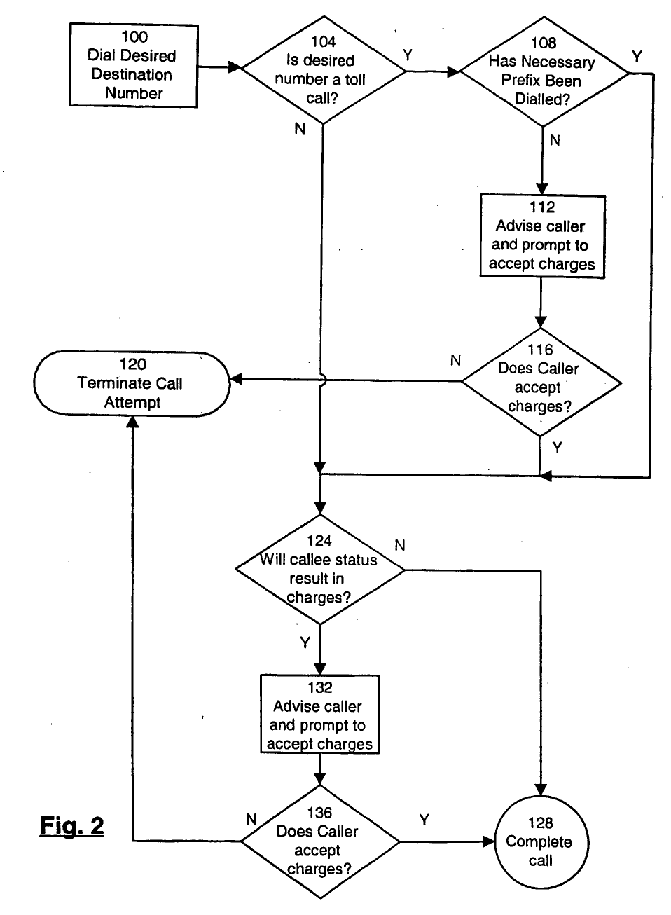

In an embodiment of the present invention, a novel method of billing telecommunications charges is provided. As shown in FIG. 2, at step 100 a caller initiates a call on telephony device 32 or wireless telephony device 36 by dialing a desired number. At step 104, the switching system of PSTN 20 determines whether toll charges should apply to the call. This determination is typically made by switching node 24, although other places of determination within PSTN 20 are within the scope of the invention. As is known to those of skill in the art, phone numbers in North America use a format defined in the North American Number Plan (NANP). The NAMP format is (AAA)-NXX-YYYY, where (AAA) is the Numbering Plan Area (NPA), also called an area code, NXX is the Central Office code, and YYYY specifies a specific line. By comparing the NPA and the Central Office code of the dialed number to a database or lookup table of prefixes and area codes which are defined as non-toll calls from the caller's switch, it can be determined if the call will incur toll charges.

The present invention is not limited to this particular method of determining toll charges and any other suitable method can be employed, as will occur to those of skill in the art. For example, if Number Portability is implemented in network 20, each subscriber can have additional information, stored in network 20, associated with their number and which identifies their location, billing category or other information need by network 20 to identify the toll status of a call to the subscriber.

Unlike the case with conventional billing systems, the determination of toll charge rates occurs at the time of the call, although modifiers to this rate (such as bulk discounts), can be applied later. It is contemplated that a conventional CDR would also created for billing purposes. The determination of toll charge rates can occur either in the same system that provides toll data for the CDR or in a separate system operable for this task.

If, at step 104, it is determined that toll charges apply to the desired connection and in calling schemes wherein the caller must dial a “1” or other toll call prefix before toll charges can be applied to their account, the method proceeds to step 108 where the caller's switch will check to see if such a prefix has been dialed. If the required prefix has not been dialed, the method will advise the caller at step 112 that the desired call will incur toll charges and prompts the caller to indicate whether they will accept the toll charges.

The logic to handle the method in this step can be provided by appropriate coding on the switch at switching node 24, or through a separate device attached to the switch. The interaction with the caller at step 112 can be provided through IVR system 48 or through the appropriate hardware and software at switching node 24 that can provide prerecorded voice prompts, synthesized speech, predefined tones or any other appropriate signal to the caller.

In calling schemes which do not require a prefix to authorize toll charges, step 108 can be bypassed with the method proceeding directly to step 112 from step 104 whenever it is determined at step 104 that toll charges will apply to the desired connection. IVR system 48 will provide a caller with notice that toll charges will apply to the call and, in some embodiments, the rate of those charges.

At step 116, the method determines the response of the caller to the prompt from step 112 and, if the caller has indicated that the charges will not be accepted, the call set up attempt terminates at step 120. If at step 116, the caller has indicated that the charges will be accepted, or if at step 108 it was determined that the necessary prefix was dialed, the method then proceeds to step 124. This determination can be made through attached IVR system 48 or through the appropriate code on switching node 24. It is contemplated that IVR system 48 would play a message like “The following call is a long-distance call. A toll of $X will be applied per minute. Press ‘1’ to accept these charges”. By pressing ‘1’, the user generates a DTMF tone that is recognizable by IVR system 48 which passes appropriate information to switching node 24 depending upon the caller's responses. Once the user has pressed ‘1’, the call is routed to the destination number. In another configuration, IVR system 48 will play a message like “The following call is a long distance call. A toll of $X will be applied per minute. Please stay on the line to complete the call”. In this case, the user can elect to stay on the line to complete the call or hang up. Other methods of determining the response of the caller are within the scope of the invention.

It is contemplated that steps 104 through 116 can be optional by allowing a caller to predefine that they will always accept toll charges. In such a case, the method will proceed directly from step 100 to step 124.

At step 124 a check is made as to the present status of the callee. As used herein the callee's “status” is defined by a variety of parameters which can be determined by the network and/or set by a callee. Specifically, one status parameter, if the callee is a mobile telephony device, can be whether or not the callee is located within its home network and/or local service area. Another status parameter in such a case can be whether the callee is willing to accept the charges for incoming calls or wishes them reflected back to the caller. A further discussion of status parameters is given below.

If, after examining the callee status at step 124, it is determined that no charges will result to the caller (for example, the callee is in the home network or the callee has defined that they will bear any additional charges), the call set up is completed at step 128. Otherwise, at step 132 the caller is provided with a suitable message from IVR system 48 advising that they will incur charges if the call is completed and the caller is prompted to accept or refuse such charges.

The actual message provided to the caller in step 132 can be varied widely and the type of message and/or the actual message can be defined as one of the parameters defining the callee status. For example, a callee may not wish a caller to know where they are located when they are outside their home network but they still want toll charges to be reflected back to the caller. In such a case, the message to the caller can merely say, “This call will be subject to a charge of $X per minute incurred by you if this call is completed”. In this case, $X is an appropriate amount to cover the toll charges and the caller will not know why the charge is incurred and/or where the callee is located.

In other cases the callee may want to advise the caller of where they are located (in general terms) and the message provided to the caller in step 132 can be, “The party you have called is presently in California and toll charges of $X per minute will be incurred by you if this call is completed” or “The party you have called is presently in the Pacific Standard Time Zone and toll charges of $X per minute will be incurred by you if you complete this call.” These messages have the advantage of also providing the caller with an indication of why the charges would be incurred and if time changes, etc. need to be considered when placing the call (allowing the caller to voluntarily defer a call which would otherwise arrive at an inappropriate time local to the present location of the callee).

It is presently contemplated that the method of billing is akin to known 900 number (pay per call) systems. In effect, the callee has created a temporary 900 number. As is known to those of skill in the art, 900 numbers typically have the telephone network provide billing services for the callee. 900 numbers bill the caller either a flat fee or a fee per minute. Other methods of billing are known. For example, Canadian patent application 2,293,098 (Shannon et al) entitled, “Arrangement for Billing or Billing Authorization Using a Telecommunication Network” discusses a variety of implementations of billing systems. Other methods of billing are within the scope of the invention.

If, at step 136, the caller accepts the charges, the call set up is completed at step 128 and the resulting charges will be billed to the caller. If the caller refuses the charges, the call attempt is terminated at step 120. It is presently contemplated that the caller will use DTMF tones to accept or refuse these charges, with the logic being handled by the appropriate switching node 24 or IVR system 48.

It is also possible to apply the above method to charges other than toll charges. For example, a callee using a mobile telephony device can specify that air time charges are to be borne by the caller for all incoming calls, and the method will proceed much like that shown in FIG. 2, but air time charges are substituted for toll charges. In fact, the method can be employed with all of toll, air time, roam and any other charges being considered and assigned to one of the callee and caller. Also, a callee can define that the charges be split in a variety of manners. For example, a callee can define that air time charges are always for the account of the callee, while other charges are for the account of the caller. The callee can also specify an allocation of toll charges. For example, when out of his home network the callee can specify that the toll charges from his home network to his present location and his air time charges are for his account, while any other toll charges will be for the caller. In a similar manner, a callee can specify that the toll charges from his home network to his present location and any other toll charges (from the caller's location to the home network) are also for the callee's account.

It is contemplated that a wide variety of parameters can be employed in defining and assessing the callee's status. In addition to the parameters mentioned above (mobile device outside of home network and whether callee is willing to accept the charges), the callee can have defined one or more caller telephone numbers (or other suitable identifiers of the caller) for which the callee can specify that they will always accept the call without notice to the caller. In such a case, a caller identified as being on the list will be processed without being notified of any charges and all charges are borne by the callee. Another example of a parameter is a time condition which alters the effect of one or more of the other status parameters. For example, a callee may specify that between working hours of 9:00 AM to 6:00 PM, calls will be accepted with charges paid by the callee and outside that period charges will be reflected to the caller's account.

Another parameter which is contemplated is that of a nuisance fee. For example, the callee can define that any caller calling within a specified time, such as the dinner hour of the callee, will incur a nuisance fee of $X. The caller is given the option of agreeing to pay the fee, or to make the call at another time. It is also contemplated that such a nuisance fee can be waived by the callee, after the call is accepted, should the callee decide to do so. This allows the callee to accept a call from a family member, for example, and to then waive the fee after determining the identity of the caller. It is further contemplated that the callee can identify a set of telephone numbers (i.e.—“free callers”) to whom the nuisance fee will not be applied.

Such a nuisance fee allows a callee to discourage telemarketers and the like as they will be charged the nuisance fee (and the callee will profit to the same amount) to disturb the callee. The ability to specify a list of “free callers” and to waive the fee once the call is established and the caller has been identified allows the callee to accommodate friends, family and other bona fide callers of interest.

It is also contemplated that the carrier providing this service can limit its use in order to prevent its abuse. For example, a carrier can limit the callee to charge a nuisance fee only outside regular working hours, or limit the fee charged/minute, or place a cap on the maximum billed nuisance fee. These restrictions can also be put in place to prevent the callee from using the service as a ‘discount’ or otherwise unauthorized (by the carrier) 900 number.

While the embodiments discussed herein are directed to specific implementations of the invention, it will be understood that combinations, sub-sets and variations of the embodiments are within the scope of the invention.

For example, PSTN network 20 can contain a hybrid of public and private communications networks networks. Alternatively, PSTN network 20 can be either a pure packet-switched network, such as the Internet, or a private network using VolP, or hybrid packet-switched/circuit-switched network. An example of the latter would be a call which is routed partially across a conventional PSTN network, and partially across an packet-switched network using VoIP, after passing through an appropriate gateway which converted the signal.

It is also contemplated that as well as telephony devices 32, network 20 can also service one or more data devices, such as personal computers, PDAs, or the data capabilities of certain cell phones. While most data services are provided on a flat-rate basis, some services are billed on a per-use basis. For example, a customer can be billed for every text message sent to him or her on the customer's cell phone. Another example would be a laptop computer equipped with a wireless modem. A customer using such a device can be billed for downloading e-mail, by either the connection time or the bytes transmitted. In these cases, the method described above can be adapted for the senders of the data messages. For example, instead of being prompted by IVR system 48, the sender of an e-mail can receive an e-mail message containing an HTML-based form that would allow the sender to accept or decline the charges. Other adaptations specific to the messaging format are within the scope of the invention.

It is also contemplated that portions of the method can be implemented separately by different carriers. For instance, a caller may use the services of a first carrier, who implements a method similar to the method as described in steps 100 to 120 of FIG. 2. The callee may use the services of a second carrier, who implements a method similar to the method as described in steps 120 to 136 of FIG. 2, starting at step 124. Completing the call requires going through the networks of both carriers. It is further contemplated that only a portion of the method may be implemented. For example, a caller may use the services of a third carrier who does not implement the method. However, if the callee uses the services of the second carrier, then the caller would still move through the method as described in steps 120 to 136 of FIG. 2, starting at step 124.

It is also contemplated that if automated methods of billing the caller based upon the status of the callee are not available, IVR system 48 can collect credit card or other payment information from the caller.

It is also contemplated that all or portions of the method described above can be implemented without requiring the intervening network to provide dedicated IVR services or billing services. It is contemplated that ‘software agents’ or the like, residing either in telephony devices 32 or within backbone network 20, can handle all or part of the voice interface, call logic, and billing arrangements. ‘Software agents’ are configurable programs running on either the telephony device or network 20, that are uniquely associated with either the subscriber number or the telephony device and which provide call and feature logic. An example of software agents is described in pending Canadian patent application 2,323,900 (Snelgrove et al).

It is further contemplated that the callee charges may not be fixed, but can be negotiated between the caller and the callee. Such a negotiation can occur automatically, based upon predetermined calling rules defined by the caller and the callee. A method for such an automated negotiation is defined in Canadian patent application 2,300,435 (Preiss).

It is also contemplated that an IVR system 48 can be collocated with each separate switching node 24 and provide service to that single switching node 24 and its respective telephony devices 32 and/or wireless telephony devices 36. Alternatively, IVR system 48 can be provided as software running within the switching node 24. It is further contemplated, that IVR system 48 can be provided as a type of software agent running within telephony device 32 or wireless telephony device 36.

It is also contemplated that a caller may not be an individual and could instead be a modem controlled by a dialing program. In such a case, IVR system 48 can switch from voice prompts to modulated data prompts which can be received by a modem. For example, IVR system 48 can first attempt to obtain an appropriate reply to a voice prompt. If no reply is received within a pre-defined time period, IVR system 48 can attempt to send a signal which will be recognized by a modem, such as a standard modem training sequence (for example, the training sequence used to establish a 1200 baud modem connection). When the calling modem recognizes the signal and responds, a connection is established to IVR system 48 which can then communicate with the modem via any suitable pre-defined protocol, such as XML messages transmitted in ASCII. The dialing program controlling the calling modem can then operate on the messages sent from IVR system 48, either by responding directly to the messages according to a script or program designed for this purpose, or by displaying the received messages to a user of the modem and receiving and forwarding to IVR system 48 replies from the user.

It is also contemplated that the callee can provide an option whereby the caller can choose to leave a message in the callee's voice mail and avoid incurring charges. For example, a caller may call with relatively unimportant news, not realizing that the callee currently faces significant roaming charges. Upon contacting the IVR system and hearing the IVR prompts, the caller elects to leave a message instead of connecting with the callee directly. It is contemplated that IVR system 48 would play a message like “The following call is a long-distance call. A toll of $X will be applied per minute. Press ‘1’ to accept these charges, or press ‘2’ to leave a voice message”. The callee can then retrieve the message at his or her discretion.

It is further contemplated that the callee can provide an option whereby the caller can redirect his or her call automatically to another phone number and avoid incurring charges. For example, a caller may call with relatively unimportant news, not realizing that the callee currently faces significant roaming charges. Upon contacting the IVR system and hearing the IVR prompts, the caller can redirect his or her call to the callee's work telephone number. It is contemplated that IVR system 48 would play a message like “The following call is a long-distance call. A toll of $X will be applied per minute. Press ‘1’ to accept these charges, or press ‘2’ to redirect your call to my office”. Such an option could be useful for a callee who is working out of a remote office for a period of time, but does not wish to change his or her local calling area.

The above-described embodiments of the invention are intended to be examples of the present invention and alterations and modifications may be effected thereto, by those of skill in the art, without departing from the scope of the invention which is defined solely by the claims appended hereto.

We claim:

1. A payment method for a telecommunications network providing a connection between a caller and a callee, comprising the steps of:
i) said caller indicating to said telecommunications network a desired callee to be connected to;
ii) said telecommunications network determining the status of said desired callee to determine if charges will be incurred by said caller if said connection is completed;
iii) if charges will be incurred by said caller, advising said caller of said charges and receiving input from said caller indicating an acceptance or refusal of said charges;
iv) completing said connection between said caller and said callee if said received input indicates acceptance by said caller;
v) posting the resulting charges to a billing account of said caller.

2. The method of claim 1 where said charges include toll rates for long distance connections.

3. The method of claim 1 where said charges includes charges for connecting to a callee via a mobile telephony device outside the home network area for said mobile telephony device.

4. The method of claim 1 where said charges include air-time usage charges for connections to a mobile telephony device.

5. The method of claim 1 wherein said status of said desired callee includes a parameter defined by said callee indicating the refusal of the callee to pay charges which would otherwise be incurred by the callee for the connection.

6. The method of claim 1 wherein said status of said desired callee includes a parameter defined by said callee indicating a list of callers for which the callee will pay said charges.

7. The method of claim 1 wherein said status of said desired callee includes a parameter defined by said callee indicating charges defined by said callee to be applied to said desired connection, said charges being credited to the billing account of said callee if said connection is completed.

8. The method of claim 1 where step (iii) further includes the step of advising the caller of the time zone said desired callee is presently located in, if different from that of the caller.

9. The method of claim 1 wherein said status of said desired callee includes a parameter defining a time period in which said charges for a connection differ from said charges for a connection outside said defined time period.

10. The method of claim 1 wherein step said advising and receiving is performed by an interactive voice response system.

11. The method of claim 1 wherein said status of said desired callee includes at least one parameter defining charges which said callee will accept.

12. The method of claim 11 wherein said status of said desired callee further includes a parameter indicating a time period in which said callee will accept said defined charges.

13. The method of claim 1 where step (v) further comprises the step of receiving input from said callee after said connection is established to instead apply said charges to the billing account of said callee.

14. The method of claim 1 wherein said billing account of said caller is a credit card.

15. The method of claim 1 wherein said billing account of said caller is a telephone company account.

16. The method of claim 1 wherein said callee has the option of leaving a voice message rather than completing said connection and incurring said charges.

17. The method of claim 1 wherein said callee has the option of redirecting the call to a different telephone number.

18. A method for allowing a caller to accept charge rates for a call before being billed said charges, in a telecommunications network consisting of a plurality of telephony devices interconnected by switching nodes, said telecommunications network being operable to determine said charge rates in advance of connecting said call, said method consisting of the following steps:
i) a caller dialing a desired destination number;
ii) said telecommunications network checking to see if charges will be incurred;
iii) said caller being advised of said charges;
iv) said caller accepting or declining said charges, and
v) if said charges are accepted, then said call to said destination number is completed.

19. The method of claim 18 where said charge rates are incurred as toll rates for long distance calls.

20. The method of claim 18 where said charges are incurred as roaming rates.

21. The method of claim 18 where said charge rates include air-time usage rates.

22. A method for allowing a callee to charge a connection fee to a caller, in a telecommunications network consisting of a plurality of telephony devices interconnected by switching nodes, said telecommunications network being operable to charge said caller for calling said callee, said method consisting the following steps:
i) a caller dialing a desired destination number;
ii) the network checking to see if a connection fee has been defined by said callee for said callee to accept the call;
iii) said caller being advised of said connection fee; and
iv) if said caller accepts said connection fee, then the call to said callee is completed and said caller is charged and said callee is credited with said connection fee.

23. The method of claim 22 where said connection fee is the roaming charges being incurred by said callee.

24. The method of claim 22 where said connection fee is the long distance charges being incurred by said callee.

25. The method of claim 22 where said connection fee is the air-time charges being incurred by said callee.

26. The method of claim 22 where said callee can determine the time periods when said connection fee will be applied.

27. The method of claim 22 where said callee can determine callers who are exempt from said connection fee.

28. The method of claim 27 where said exemptions are determined from a list of potential callers defined by said callee.

29. The method of claim 27 where said callee can determine to exempt said caller from said connection fee after said call is completed.

30. A telecommunications network operable to collect payment from a caller upon completion of the connection to a callee, with said charges being determined by the status of said callee, consisting of:
i) at least two switching nodes, of which at least one of said at least two switching nodes is operable to determine said status of said callee;
ii) a backbone network connecting said at least two switching nodes;
iii) at least two telephony devices operable to communicate with said at least two switching nodes; and
iv) at least one interactive voice response system, operable to notify said caller of said charges and receive acceptance of said charges by said caller.

31. The telecommunications network of claim 30 where said charges include toll rates for long distance connections.

32. The telecommunications network of claim 30 where said charges includes charges for connecting to a callee via a mobile telephony device outside the home network area for said mobile telephony device.

33. The telecommunications network of claim 30 where said charges include air-time usage charges for connections to a mobile telephony device.

34. The telecommunications network of claim 30 wherein said status of said desired callee includes a parameter defined by said callee indicating the refusal of the callee to pay charges which would otherwise be incurred by the callee for the connection.

35. The telecommunications network of claim 30 wherein said status of said desired callee includes a parameter defined by said callee indicating a list of callers for which the callee will pay said charges.

36. The telecommunications network of claim 30 wherein said status of said desired callee includes a parameter defined by said callee indicating charges defined by said callee to be applied to said desired connection, said charges being credited to the billing account of said callee if said connection is completed.

37. The telecommunications network of claim 30 wherein said status of said desired callee includes a parameter defining a time period in which said charges for a connection differ from said charges for a connection outside said defined time period.

38. The telecommunications network of claim 30 wherein said status of said desired callee includes at least one parameter defining charges which said callee will accept.

39. The telecommunications network of claim 38 wherein said status of said desired callee further includes a parameter indicating a time period in which said callee will accept said defined charges.

40. The telecommunications network of claim 30 wherein said interactive voice response system is software running on at least one of said backbone network and said at least one switching node.

41. The telecommunications network of claim 30 wherein at least one of said telephony device is a mobile telephony device.

42. The telecommunications network of claim 30 wherein said backbone network is the PSTN.

43. The telecommunications network of claim 30 wherein at least a portion of said backbone network is operable to use VoIP.

44. The telecommunications network of claim 30 wherein said at least one of said switching nodes is operable to service one or more data devices.
